(19) United States
(12) Patent Application Publication
(10) Pub. No.: US 2026/0085775 A1
(43) Pub. Date: Mar. 26, 2026

(54) PEX FITTING TO FEMALE GARDEN HOSE FITTING ADAPTER

(71) Applicant: Jason Anthony Steuber, Olathe, KS (US)

(72) Inventor: Jason Anthony Steuber, Olathe, KS (US)

(21) Appl. No.: 18/895,301

(22) Filed: Sep. 24, 2024

(51) Int. Cl. F16L 19/025; F16L 11/12

(52) U.S. Cl. CPC F16L 19/025; F16L 11/12

(57) ABSTRACT

A male pipe connector includes a cross-linked polyethylene specification (PEX) barb, at least one PEX rib positioned on the PEX barb, and a male base connected to the PEX barb. The male base is configured to connect to a female garden hose thread specification (GHT) connector having interior threads for connecting to a male GHT connector.

### BACKGROUND OF THE DISCLOSURE

Garden hoses are commonly used for water delivery in various applications. These hoses are typically connected using their garden hose thread specification (GHT) connectors to outdoor faucets or spigots, which are part of a traditional, permanent, or semi-permanent water supply system. Cross-linked polyethylene specification (PEX) piping systems, which are frequently used as an alternative to traditional materials such as copper or PVC, are generally used indoors.

### SUMMARY

In some embodiments, a male pipe connector includes a cross-linked polyethylene specification (PEX) barb, at least one PEX rib positioned on the PEX barb, and a male base connected to the PEX barb. The male base is configured to connect to a female garden hose thread specification (GHT) connector having interior threads for connecting to a male GHT connector.

In some embodiments, an adapter includes a female garden hose thread (GHT) connector having interior threads and configured to connect to a male GHT connector, and a male cross-linked polyethylene specification (PEX) connector configured to connect to a PEX tubing. The adapter includes an interface between the male PEX connector and the female GHT connector connecting the male PEX connector to the female GHT connector. The adapter includes a tightener positioned around an outer surface of the female GHT connector.

In some embodiments, a method of using a piping adapter includes connecting a female garden hose thread specification (GHT) connector of the adapter to a male GHT connector of a garden hose, connecting a cross-linked polyethylene specification (PEX) piping to a male PEX connector of the adapter, and flowing a fluid between the garden hose and the PEX piping through the adapter.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 illustrates a side cross-sectional view of an adapter, according to at least one embodiment of the present disclosure;

FIG. 1-2 illustrates a side cross-section view of an example assembly of the adapter of FIG. 1-1 with a male GHT connector and a PEX piping connected thereto, according to at least one embodiment of the present disclosure;

FIG. 1-3 illustrates a first perspective view of the adapter of FIG. 1-1, according to at least one embodiment of the present disclosure;

FIG. 1-4 illustrates a second perspective view of the adapter of FIG. 1-1, according to at least one embodiment of the present disclosure;

FIG. 1-5 illustrates a side view of the adapter of FIG. 1-1, according to at least one embodiment of the present disclosure;

FIG. 1-6 illustrates an exploded view of the adapter of the adapter of FIG. 1-1, according to at least one embodiment of the present disclosure;

FIG. 1-7 illustrates an example of various dimensions, features, and other configurations of a barb in accordance with a specification for PEX tubing, according to at least one embodiment of the present disclosure;

FIG. 2 illustrates a side cross-sectional view of an adapter, according to at least one embodiment of the present disclosure;

FIG. 3-1 illustrates a perspective view and a top view of a female connector implemented with a tightener, according to at least one embodiment of the present disclosure;

FIG. 3-2 illustrates a perspective view and a top view of a female connector implemented with a tightener, according to at least one embodiment of the present disclosure;

FIG. 3-3 illustrates a perspective view and a top view of a female connector implemented with a tightener, according to at least one embodiment of the present disclosure;

FIG. 3-4 illustrates a perspective view and a top view of a female connector implemented with a tightener, according to at least one embodiment of the present disclosure;

FIG. 3-5 illustrates a perspective view and a top view of a female connector implemented with a tightener, according to at least one embodiment of the present disclosure;

FIG. 4 illustrates a method 400 or a series of acts for using a piping adapter as described herein, according to at least one embodiment of the present disclosure; and

FIG. 5 illustrates a method 500 or a series of acts for assembling a piping adapter as described herein, according to at least one embodiment of the present disclosure.

### DETAILED DESCRIPTION

This disclosure generally relates to an adapter having a female garden hose thread specification (GHT) connector and a male cross-linked polyethylene specification (PEX) connector for connecting a PEX piping to a male GHT connector of a garden hose. The male PEX connector and the female GHT connector of the adapter are connected or connectable. In some cases, the connection is a rotatable connection such that the female GHT connector may swivel. The adapter may include a seal, such as a washer or gasket, positioned within the female GHT connector. The seal may be positioned at a base of the female GHT connector and/or a base of the male PEX connector. In this way, when a male GHT connector is connected to the female GHT of the adapter, the adapter may seal the male GHT connector against the male PEX connector to create a fluid seal between the male PEX connector (e.g., and a PEX piping connected thereto) and the male GHT connector (e.g., and a garden hose connected thereto). The female GHT connector may include a tightener positioned around an outer surface of the female GHT connector to facilitate tightening the male GHT connector and creating the fluid seal in this way. For instance, the tightener may be implemented as a hex nut, a ribbed surface, knurling, etc. In this way, the adapter may facilitate connecting PEX piping to a male GHT connector, for facilitating a sealed flow of gas, liquid, or other fluid therebetween.

Garden hoses are typically used for water delivery in various applications. These hoses are typically connected, using their garden hose thread specification (GHT) connectors, to outdoor faucets or spigots, which are part of a traditional, permanent, or semi-permanent water supply system. For instance, the GHT specification has been in use since at least 1963, when it was established as the standard for garden hose connections by the National Fire Protection Association (NFPA) and later by ANSI-ASME B1.20.7.

Permanent water supply systems, such as those within a house or other building, are now quite commonly implemented through use of a cross-linked polyethylene specification (PEX) piping system, which has become a popular alternative to traditional materials such as copper or PVC due to its flexibility, ease of installation, and resistance to corrosion, scaling, and freezing. For instance, the PEX specification has been in use since at least 1968, when it was invented by German scientist Thoms Engle.

A garden hose having GHT connectors may typically be connected to a spigot of a permanent water supply system, for example, at a female end or female or male connector of the garden hose. Accordingly, water delivery systems including both PEX piping and garden hose may typically be implemented for providing water delivery from the PEX piping to the garden hose, for example, via a male GHT connector of the PEX piping system connecting to a female GHT connector of the garden hose.

However, the inventor has identified a growing need to implement water supply systems having both PEX piping and garden hose via a connection of a male GHT connector of the garden hose to the PEX piping, for example, for providing water delivery from the garden hose to the PEX piping. For instance, the inventor has identified that such a need may arise to extend or modify water supply systems to areas where a permanent water supply system is unavailable or impractical. For example, it may be advantageous to implement an ancillary water supply system, e.g., with PEX piping, in an area that is remote, detached, or otherwise removed from PEX piping of a primary water supply system. To illustrate, a remote water supply system may be installed in a garden, ancillary building or structure, or otherwise removed from a building or site having a primary water supply system. In these and other cases, it may be advantageous to connect the ancillary water supply system to the primary water supply system with a garden hose to provide a flow of water from the primary water system to the ancillary water system through the garden hose. Connection via a garden hose in this way may facilitate ease of implementation, adaptability, reduced cost, seasonal use, etc.

One or more of the adapters described herein may be implemented to achieve these advantages. For example, one or more of the adapters described herein may be implemented to connecting garden hoses to PEX systems in this way without requiring multiple components to ensure a secure, leak-free connection. For instance, one or more embodiments described herein may facilitate connecting male GHT connectors to PEX systems without having to first connect and/or adapt both the PEX piping and the garden hose to another piping specification or standard, such as to a national pipe tapered (NPT) specification, in order to connect the male GHT connector of the garden hose to the PEX piping through multiple components. Accordingly, embodiments described herein provide a valuable solution over other overly complex alternatives, which may require tools and materials that may not be readily accessible to the average homeowner (e.g., one having ordinary skill in the art).

Accordingly, one or more embodiments described herein overcome these limitations by providing a piping adapter having a female GHT connector and a PEX insertion or crimp fitting, in order to facilitate a direct connection of a PEX piping system to a male GHT connector of a garden hose. Such an adapter provides, in one or more embodiments, a practical and cost-effective solution for homeowners seeking to implement water supply systems comprising both PEX piping and garden hose, for example, for extending or modifying their water supply systems for outdoor or ancillary use.

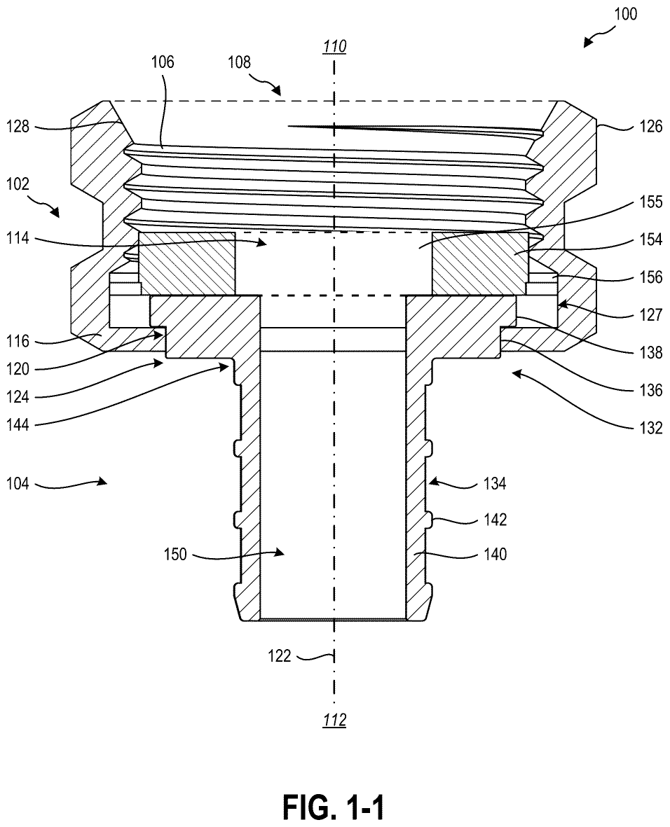

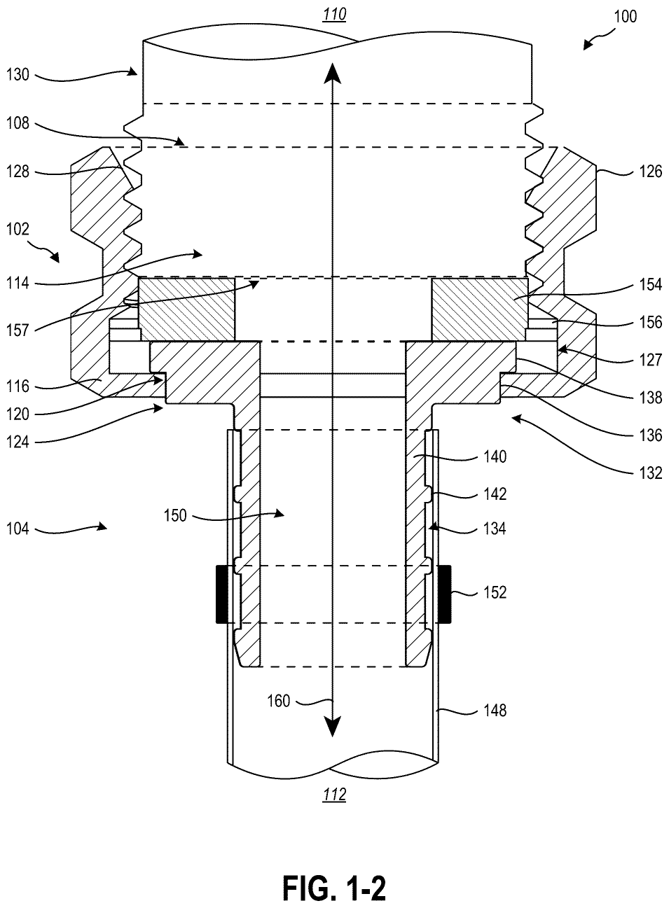

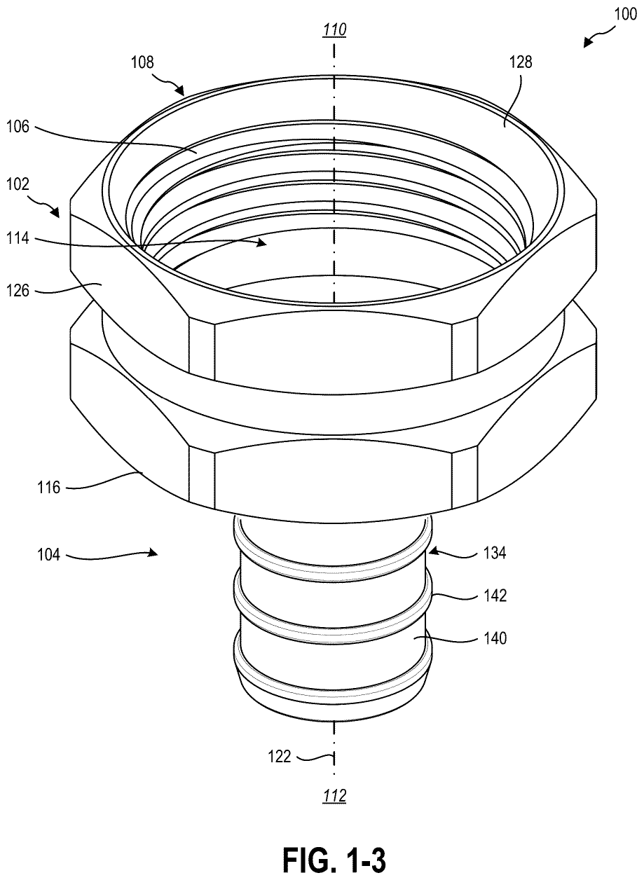

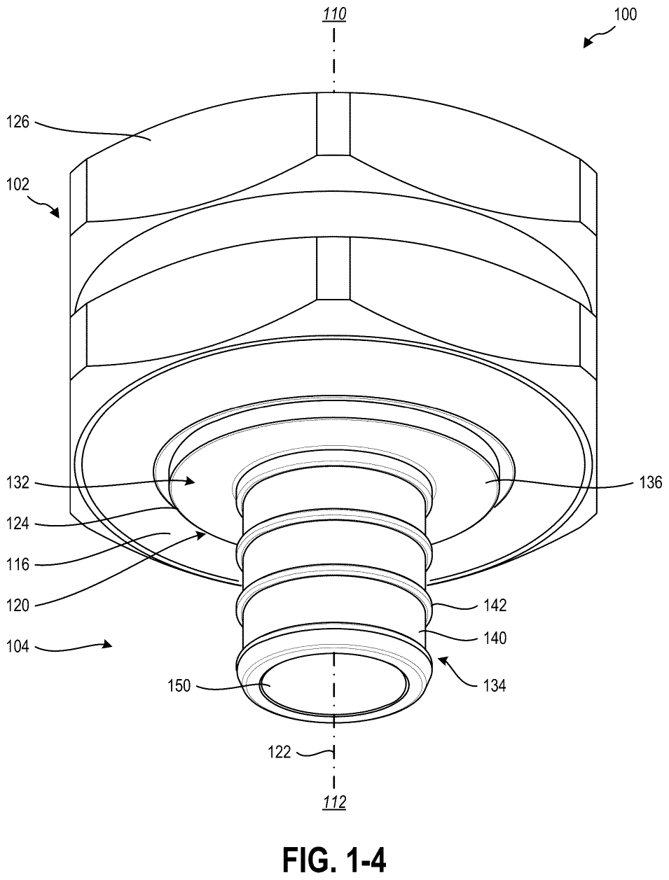

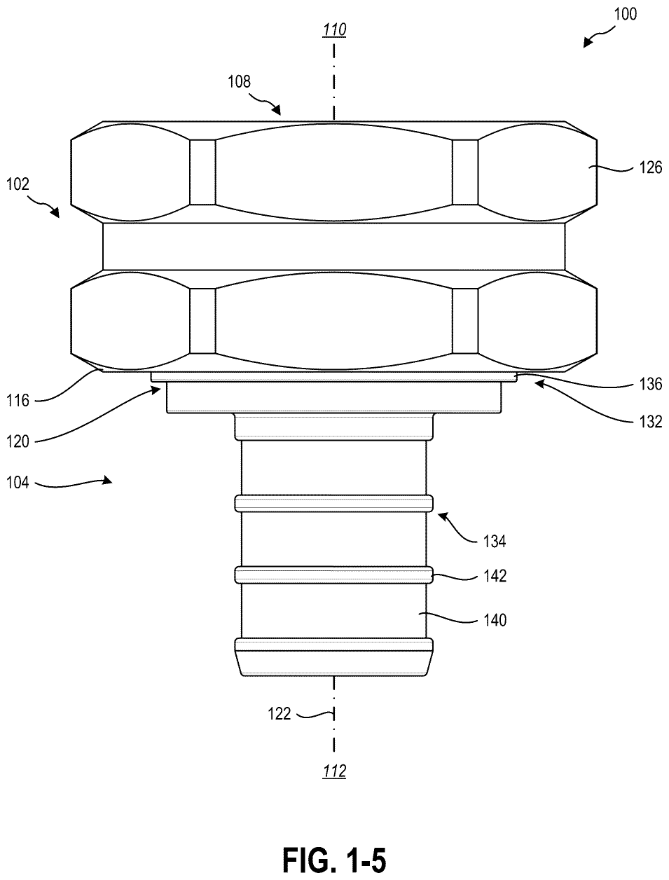

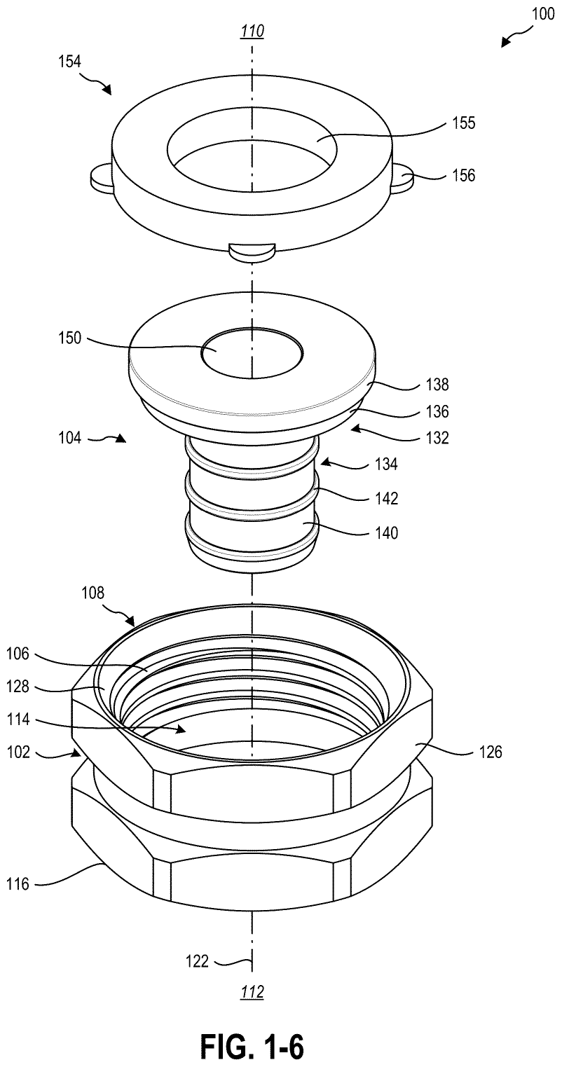

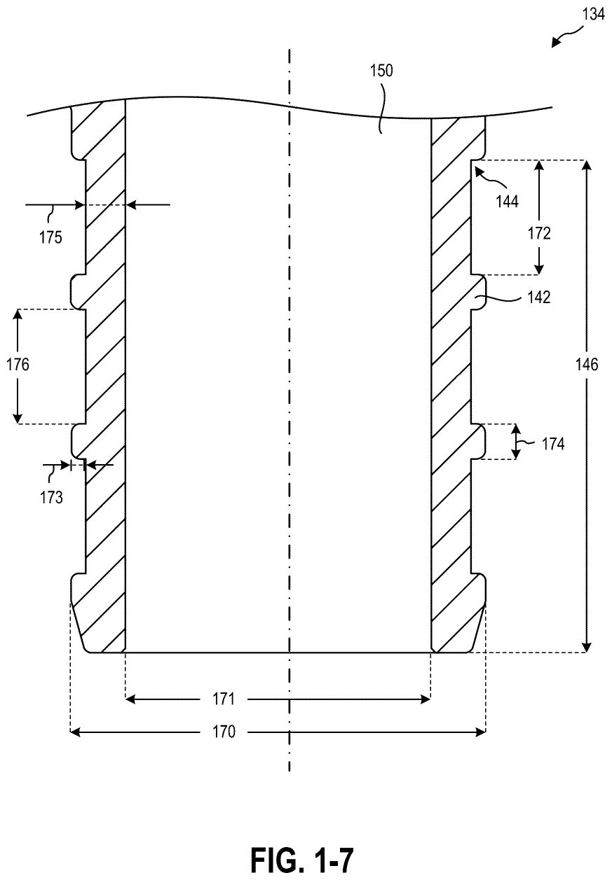

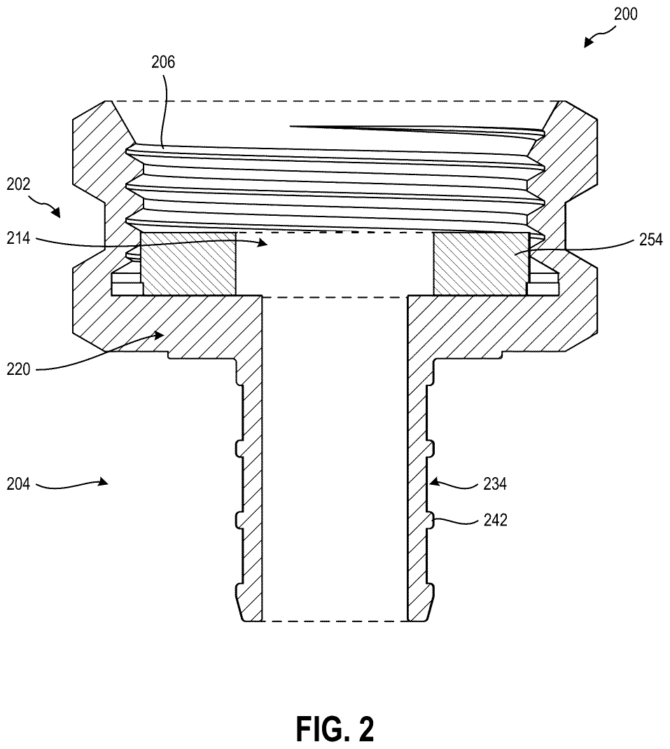

FIGS. 1-1 through 1-6 illustrate example views of an adapter 100 as described herein, according to one or more embodiments of the present disclosure. Specifically, FIG. 1-1 illustrates a side cross-sectional view of the adapter 100, according to at least one embodiment of the present disclosure, and FIG. 1-2 illustrates a side cross-section view of an example assembly of the adapter 100 with a male GHT connector 130 and a PEX tubing 148 connected thereto, according to at least one embodiment of the present disclosure. FIG. 1-3 illustrates a first perspective view, FIG. 1-4 illustrates a second perspective view, FIG. 1-5 illustrates a side view, and FIG. 1-6 illustrates an exploded view of the adapter 100, according to one or more embodiments of the present disclosure. For ease of discussion, FIGS. 1-1 through 1-6 will be discussed together, with reference in some cases to specific figures of FIGS. 1-1 through 1-6.

The adapter 100 includes a female connector 102 and a male connector 104. The female connector 102 may be a female portion of the adapter 100 in that the female connector 102 may have a generally open shape or form. For instance, the female connector 102 defines an opening 108. For example, the female connector 102 may define an internal volume or inner bore 114 that may be open to an upper end 110 of the adapter 100 at the opening 108. As shown in FIG. 1-2, the female connector 102 may receive or accept a male GHT connector 130 through the opening 108. As described herein, a seal 154 and/or the male connector 104 may insert into the female connector 102 through the opening 108.

The inner bore 114 may pass at least partially through the female connector 102 from the opening 108. The inner bore 114 may be a central bore and/or may be longitudinally aligned with an axis 122 of the adapter 100. The inner bore 114 may be substantially round. The inner bore 114 may extend from the opening 108 to a female base 116 of the female connector 102. The female base 116 may form an interface 120 or connection between the female connector 102 and the male connector 104. For example, the female base 116 may include (e.g., and/or the interface 120 may be formed by) an aperture 124 through which at least a portion of the male connector 104 may protrude. The aperture 124 may have a smaller or reduced diameter to that of the inner bore 114 such that an open volume passes through the entirety of the female connector 102.

The female connector 102 may include one or more interior threads 106 at an inner diameter of the female connector 102. For instance, the threads 106 may be formed along the inner bore 114. The threads 106 may span one, or multiple revolutions around the inner diameter of the female connector 102. The female connector 102 may have a relief 127 formed therein. The relief 127 may be positioned below the threads 106 (e.g., below in the non-limiting orientation of the adapter 100 shown herein). For instance, the relief 127 may be a portion of the inner bore 114 formed between the threads 106 and the female base 116. The female connector 102 may include a taper 128. The taper 128 may be a tapered or sloped section of the inner bore 114 at or near the opening 108. The taper 128 may facilitate guiding or directing one or more components that are inserted into the female connector 102 through the opening 108, such as guiding and/or aligning threads of the male GHT connector 130 with the threads 106 of the female connector 102.

The female connector 102 may be a female connector conforming to a GHT specification (e.g., and/or a national hose thread (NH) specification), such as a specification for ¾-inch GHT connectors. For instance, the female connector 102 may have a nominal inner diameter of ¾ inches. The interior threads 106 may be parallel threads and may have a thread spacing and/or pitch of 11.5 threads per inch. In this way, the female connector 102 may be a female GHT connector, and may be configured to connect with a threaded connection to the male GHT connector 130.

The female connector 102 may include a tightener 126. The tightener 126 may be positioned around an outer surface of the female connector 102. The tightener 126 may facilitate tightening the female connector 102 to and/or against the male GHT connector 130. For instance, the tightener 126 may include one or more geometries or features that may facilitate firmly grasping, holding, or securing the female connector 102 in order to rotate the female connector 102 with respect to the male GHT connector 130 (e.g., or vice versa). In this way the threaded connection between the female connector 102 and the male GHT connector 130 may be tightened. In some embodiments, the tightener 126 may include geometries or features for interfacing with a tool or other implement to secure the female connector 102 and thereby tighten the threaded connection. For example, as shown and described in further detail in connection with FIGS. 3-1 through 3-5, the tightener 126 may be implemented as one or more of a hexagonal nut, an octagonal nut, one or more ribs, one or more wings, knurling, or any other suitable tightening feature or geometry, and combinations thereof. In some embodiments, the tightener 126 may be implemented as two or more tightening geometries or features. For example, as shown, the tightener 126 may be implemented as two separate sections or portions of a hexagonal nut. In some cases, the tightener 126 is a hexagonal nut as one continuous section or portion. In other examples, the tightener 126 may be implemented as two or more sections of knurling or ribs around the outer surface of the female connector 102. The tightener 126 may be implemented as any combination of tightening features in one, two, or more continuous or discontinuous sections. In this way the tightener 126 may facilitate tightening the adapter 100 based on firmly grasping or grabbing the female connector 102.

As mentioned, the adapter 100 includes the male connector 104. The male connector 104 may include a male base 132 and a barb 134. The male base 132 may have a gauge section 136 and a flange section 138. The gauge section 136 may be positioned below (in this example orientation) the flange section 138. The gauge section 136 may be smaller and/or may have a smaller diameter or other dimension than that of the flange section 138.

The male connector 104 may interface with and/or connect with the female connector 102 at or with the male base 132. For example, the gauge section 136 may at least partially insert into, engage with, or interface with the aperture 124. The gauge section 136 may in this way act to position the male connector 104 with respect to the female connector 102. In this way the gauge section 136 may be a means for positioning the male connector 102 with respect to the female connector 104. For example, the gauge section 136 may be sized and/or shaped complimentary to the aperture 124. For instance, in some cases, the aperture may be substantially round or circular, and the gauge section 136 may accordingly be round or circular with substantially the same diameter. The aperture 124 and gauge section 136 may be formed by other complimentary shapes and/or geometries. For example the aperture 124 and gauge section 136 may each be oval, elliptical, square, hexagonal, octanol, any other polygon, or any other uniform or non-uniform shape such that the gauge section 136 may fit into and be positioned in place by the shape and/or form of the aperture 124. In some embodiments, the aperture 124 and the gauge section 136 have different shapes and/or forms. For example, the aperture 124 may have one shape, and the gauge section 136 may have another, different shape. These shapes may be complimentary in that the shape of the gauge section 136 may fit into the aperture 124 and may position the gauge section 136 accordingly. For instance, the aperture 124 may be round, and the gauge section 136 may be hexagonal, octanol, square, star-shaped, or any other shape that may fit within the round aperture 124 and may maintain a position of the gauge section 136. In some embodiments, such a configuration may permit the gauge section 136 to rotate. In this way, the gauge section 136 and aperture 124 may be shaped and configured to interface in a variety of ways in order to position the gauges section 136.

In some embodiments, the gauge section 136 has a thickness that is substantially the same as a thickness of the female base 116. In some embodiments, the gauge section 136 is thicker than a thickness of the female base 116, or the female base 116 may be thicker than a thickness of the gauge section 136. For instance, the gauge section 136 may, in some cases, protrude at least somewhat from the aperture 144.

The flange section 138 may have a wider dimension (e.g., radius) than that of the gauge section 136 such that the flange section 138 may extend laterally further than the gauge section 136. In this way, the flange section 138 may extend laterally past an outer extent of the aperture 124 such that the male connector 104 (e.g., the male base 132) may not pass through the female connector 102 at the aperture 124. Accordingly, the male connector 104 may assemble and/or connect to the female connector 102 based on the gauge section 136 inserting into and interfacing with the aperture 124.

In this way, the flange section 138 may act as a means of retaining the male connector 104 in the female connector 104, or of retaining the male connector 104 from passing through the aperture 124. In some embodiments (e.g., as shown), the flange section 138 may be substantially round. The flange section 138 may be any other shape. For example, the flange section 138 may be square, hexagonal, octagonal, any other polygonal shape, oval, elliptical, or any other uniform or non-uniform shape. In some embodiments, the flange section 138 may extend laterally further toward the wall of the relief 127 than that shown, or may extend laterally less than that shown. The flange section 138 may be thicker or thinner than that shown. The flange section 138 may have a substantially flat upper surface, or may have a non-flat surface, including a non-uniform surface with flat and/or non-flat sections.

In some embodiments, the male base 132 may seat into the female base 116. For example, the gauge section 136 may seat into, insert into, or otherwise be positioned within the aperture 124, and a position of the male connector 104 may accordingly be maintained within the female connector 102. In some embodiments, the male connector 104 may be aligned with the axis 122. For example, the male connector 104 and the female connector 102 may be coaxial.

In some embodiments, the male base 132 may be positioned in the female base 116 with a secured, or fixed fitment. For example, the male base 132 may be positioned within the female base 116 with a press fit, friction fit, or interference fit. The male base 132 may be glued, fastened, welded, brazed, or otherwise permanently or semi-permanently connected in the female base 116.

In some embodiments, the male base 132 may be positioned within the female base 116 with a rotatable connection. For instance, the interface 120 between the male base 132 and the female base 116 may be defined by a clearance, gap, float, or tolerance such that the male base 132 may be permitted to rotate or swivel with respect to the female base 116, for example, around the axis 122 (or vice versa). The interface 120 may include a lubricant such as oil, grease, silicon, graphite, etc. to facilitate the rotation of the male connector 104 in this manner. The rotatable connection in this way may facilitate the female connector 102 rotating or swiveling with respect to the male connector 104, for example, to facilitate tightening the female connector 102 to the male GHT connector 130.

As mentioned above, the male connector 104 includes a barb 134. The barb 134 may have a somewhat elongate shape and/or form, and may protrude from the male base 132 toward a lower end 112 of the adapter 100. For example, the barb 134 may include a barrel 140 having a substantially cylindrical shape which may extend from the gauge section 136. The barrel 140 may have an outer diameter that is smaller than the gauge section 136 and/or the aperture 124. One or more ribs 142 may be positioned a long a length of the barrel 140. For example, the barb 134 may include 1, 2, 3, 4, 5, 6, or more ribs 142 positioned on the barrel 140. In some embodiments, a distal end of the barb 134 (e.g., lower end 112 of the adapter) may include a taper, slope, or chamfer, for instance, to facilitate inserting the barb 134 into a corresponding PEX tubing. The chamfer may be between 10° and 30° as measured from the axis 122. In some embodiments, this chamfer may be considered one of the ribs 142.

The barb 134 may be configured according to a PEX specification or standard for PEX fittings. For instance, the barb 134 may be confirmed in accordance with the American Society for Testing and Materials (ASTM) standard F1807, also known as the “Standard Specification for Metal Insert Fittings Utilizing a Copper Crimp Ring for SDR9 Cross-linked Polyethylene (PEX) Tubing and SDCR Polyethylene of Raised Temperature (PE-RT) Tubing,” which is hereby incorporated by reference in its entirety. For example, PEX specification may dictate or otherwise indicate various sizes, geometries, dimensions, and other features for the barb 134 in order that the barb 134 may accept, insert into, connect to, or otherwise be compatible with PEX tubing. For example, as shown in FIG. 1-2, the barb 134 may insert into a PEX tubing 148 and may connect to the PEX tubing 148 for providing a secure and fluidly sealed connection between the male connector 104 and the PEX tubing 148. In this way, the barb 134 may be a PEX insertion fitting for inserting into the PEX tubing 148. In some embodiments, the barb 134 may be a PEX crimp fitting, for example, for connecting with the PEX tubing 148 via a crimp fastener 152. For example, the crimp fastener 152 may be positioned around the PEX tubing 148 and the barb 134 and may be tightened or reduced in size in order to secure the PEX tubing 148 around the barb 134. For instance, the crimp fastener 152 may be representative of a crimp ring, pinch clamp, sleeve, or other collapsible, tightenable, or crimpable component as is used in connection with PEX fittings.

FIG. 1-7 illustrates an example of various dimensions, features, and other configurations of the barb 134 in accordance with the specification for PEX tubing, according to at least one embodiment of the present disclosure. As mentioned above, the barb 134 includes one or more ribs 142. The barb 134 may be defined by an outer rib diameter 170. The male connector 104 may have an inner bore 150 which may pass through an entirety of the male connector 104, from the male base 132 through the barb 134. Accordingly, the barb 134 may be defined by an inner diameter 171 of the inner bore 150. The barb 134 may have a tube stop 144 such as a shoulder or chamfer on the barrel 140 between the barb 134 and the male base 132. The barb 134 may be defined by a distance 172 from the tube stop 144 to first rib 142 on the barb 134. The barb 134 may have a length 146, which may be measured from the tube stop 144 to the distal end of the barb 134. The length 146 may be an insertion length for inserting the barb 134 into the PEX tubing. The barb 134 may be defined by a rib height 173 of the ribs 142. The barb 134 may be defined by a rib width 174 of the ribs 142. The barb 134 may be defined by a rib spacing 176 between the ribs 142. The barb 134 may be defined by a required (e.g., minimum) number of ribs 142. The barb 134 may be defined by a wall thickness 175 of the barrel 140.

In some embodiments, the barb 134 may be configured in accordance with a nominal diameter for PEX fittings and/or PEX tubing in accordance with the PEX specification. For example, the barb 134 may be configured according to a nominal diameter or sizing of any of ⅜-inch, ½-inch, ⅝-inch, ¾-inch, or 1-inch PEX fittings and/or PEX tubing.

In some embodiments, the barb 134 may be configured in accordance with a ⅜-inch nominal diameter. For instance, the outer rib diameter 170 may be about 0.345 inches +/− about 0.004 inches. The inner diameter 171 may be about 0.23 inches. The distance 172 from the tube stop 144 to the first rib 142 may be from about 0.180 inches to about 0.224 inches. The insertion length 146 may be a minimum of about 0.625 inches. The rib height 173 may be a minimum of about 0.013 inches. The rib width 174 may be about 0.03 inches to about 0.05 inches. The rib spacing 176 may be about 0.120 inches to about 0.145 inches. The number of ribs 142 may be at least 2 ribs. The wall thickness 175 may be a minimum of about 0.025 inches.

In some embodiments, the barb 134 may be configured in accordance with a ½-inch nominal diameter. For instance, the outer rib diameter 170 may be about 0.471 inches +/− about 0.004 inches. The inner diameter 171 may be about 0.35 inches. The distance 172 from the tube stop 144 to the first rib 142 may be from about 0.180 inches to about 0.224 inches. The insertion length 146 may be a minimum of about 0.625 inches. The rib height 173 may be a minimum of about 0.013 inches. The rib width 174 may be about 0.03 inches to about 0.05 inches. The rib spacing 176 may be about 0.120 inches to about 0.145 inches. The number of ribs 142 may be at least 2 ribs. The wall thickness 175 may be a minimum of about 0.028 inches.

In some embodiments, the barb 134 may be configured in accordance with a ⅝-inch nominal diameter. For instance, the outer rib diameter 170 may be about 0.570 inches +/− about 0.004 inches. The inner diameter 171 may be about 0.451 inches. The distance 172 from the tube stop 144 to the first rib 142 may be from about 0.180 inches to about 0.224 inches. The insertion length 146 may be a minimum of about 0.625 inches. The rib height 173 may be a minimum of about 0.013 inches. The rib width 174 may be about 0.03 inches to about 0.05 inches. The rib spacing 176 may be about 0.120 inches to about 0.145 inches. The number of ribs 142 may be at least 2 ribs. The wall thickness 175 may be a minimum of about 0.032 inches.

In some embodiments, the barb 134 may be configured in accordance with a ¾-inch nominal diameter. For instance, the outer rib diameter 170 may be about 0.667 inches +/− about 0.004 inches. The inner diameter 171 may be about 0.53 inches. The distance 172 from the tube stop 144 to the first rib 142 may be from about 0.180 inches to about 0.224 inches. The insertion length 146 may be a minimum of about 0.625 inches. The rib height 173 may be a minimum of about 0.013 inches. The rib width 174 may be about 0.03 inches to about 0.05 inches. The rib spacing 176 may be about 0.120 inches to about 0.145 inches. The number of ribs 142 may be at least 2 ribs. The wall thickness 175 may be a minimum of about 0.037 inches.

In some embodiments, the barb 134 may be configured in accordance with a 1-inch nominal diameter. For instance, the outer rib diameter 170 may be about 0.856 inches +/− about 0.004 inches. The inner diameter 171 may be about 0.71 inches. The distance 172 from the tube stop 144 to the first rib 142 may be from about 0.180 inches to about 0.224 inches. The insertion length 146 may be a minimum of about 0.795 inches. The rib height 173 may be a minimum of about 0.015 inches. The rib width 174 may be about 0.03 inches to about 0.05 inches. The rib spacing 176 may be about 0.120 inches to about 0.145 inches. The number of ribs 142 may be at least 3 ribs. The wall thickness 175 may be a minimum of about 0.041 inches.

In this way, the male connector 104 may be a male PEX connector and may be configured in accordance with a variety of different PEX sizes and/or nominal diameters in order to facilitate implementing the adapter 100 in connection with many different PEX applications. In some embodiments, the adapter 100 may be configured to operate at and/or withstand an operating pressure of up to 80 psi, up to 100 psi, up to 150 psi, up to 160 psi, up to 200 psi, or more. For instance, the adapter 100 may be configured to seal the male connector 104 to the male GHT connector 130 up to the pressure rating. In another example, the adapter 100 maybe configured to seal the male connector 102 to a PEX pipe up to the pressure rating.

Accordingly, the barb 134 may be specifically configured in accordance with the PEX specification. This may be in contrast to, for example, a barb, fitting, and/or adapter having a size, shape, and/or form configured to interface with other piping specifications, such as a barbed fitting pipe specification, a polybutylene (PB) pipe specification, or other pipe specification. For example, PB tubing and/or fittings are generally understood to not be compatible or interchangeable with that of PEX tubing and/or fittings. Similarly, barbed fitting tubing and/or fittings are generally understood to not be compatible or interchangeable with that of PEX tubing.

Turning back to FIGS. 1-1 through 1-6 generally, in some embodiments, the adapter 100 includes a seal 154. The seal 154 may facilitate sealing the male connector 104 to the male GHT connector 130 (e.g., when connected to the female connector 102). For instance, the seal 154 may be positioned within the female connector 102. In some cases, the seal 154 is positioned at, near, or adjacent the female base 116, the male base 132, and/or the interface 120. For example, the flange section 138 of the male base 132 may be substantially flat, and the seal 154 may seal against the flat surface of the flange section 138. In this way, when the male GHT connector 130 is inserted into the female connector 102, a distal end 157 of the male GHT connector 130 may contact the seal 154. Accordingly, the distal end 157 of the male GHT connector 130 may be tightened against the seal 154 as the male GHT connector 130 is tightened within the female connector 102. Similarly, the seal 154 may tighten against the male base 132 of the male connector 104 such that the male connector 104 and the male GHT connector 130 may be sealed to each other. The sealed connection of the male connector 104 and the male GHT connector 130 in this way may be a fluid seal, for example, to seal a flow of gas, liquid, or other fluid. For instance, the seal 154 may include a fluid passage 155 positioned at a center or internal portion of the seal 154 such that a fluid may pass through the seal 154, for example, from the male GHT connector 130 to the male connector 104 (or vice versa). In some cases, the seal may be substantially circular or round, and may be positioned coaxially with the male connector 104 and/or the female connector 102.

In some embodiments, the seal 154 may be implemented as a (e.g., separate) sealing element, such as a washer, gasket, O-ring, or other suitable sealing element separate from the female connector 102 and/or the male connector 104. For example, the seal 154 may be a component positioned between the male GHT connector 130 and the male connector 104 and may be at least somewhat compressed in order to seal these two elements together. The seal 154 may be made of rubber, silicon or other polymer, neoprene, paper, metal, cork, foam, or other suitable sealing material.

In some embodiments, the seal 154 may be implemented as a mechanical seal, such as via a mating of the male GHT connector 130 with the male connector 104. For example, the male GHT connector 130 and the male connector 104 may each have mating geometries and/or surfaces that may interface to form a seal, for example, without a separate sealing component. In this way, the adapter 100 may include the seal 154 to provide a fluid seal between a male GHT connector and a PEX tubing to which the adapter 100 is connected.

In some embodiments, the seal 154 may include or more retainers 156 for positioning and/or maintaining the seal 154 in place. For example, the retainers 156 may include one or more ears, wings, lips, ribs, or other features which may extend at least somewhat from the seal 154. The retainers 156 may extend in this way and may engage the female connector 102 at the relief 127 in the inner bore 114. The seal 154 may be assembled with the female connector 102 by being pressed into the female connector 102, and the retainers 156 may deform somewhat in order that the seal 154 may pass by the threads 106 of the inner bore 114. Once past the threads 106, the retainers 156 may relax into the relief 127 below the threads 106. In this way, the retainers 156 may retain the seal 154 in position, for example, near the male base 132.

In some embodiments, the retainers 156 retaining the position of the seal 154 in this way may also facilitate retaining a position of the male connector 104 in the adapter 100. For example, as shown in FIG. 1-6 the male connector 104 may assemble with the female connector 102 through the opening 108 of the female connector. As described herein, the male connector 104 may seat into the female connector 102 at the aperture 124, and in some cases may swivel. The retainers 156 may engage the female connector 102 at the relief 127 to maintain the position of the seal 154, which may also prevent the male connector 104 from passing back through the female connector 102 (e.g., through the opening 108), and in this way may prevent the adapter 100 from falling apart.

In some embodiments, the male connector 104 and the female connector 102 are made of the same material, or may be made of different materials. For example, the male connector 104 and/or the female connector may be made of one or more of brass, copper, iron, steel (galvanized, stainless, etc.), lead, plastic, PVC, CPVC, ABS, any other polymer, or any other suitable material and combinations thereof. In accordance with at least one embodiment of the present disclosure, the male connector 104 and female connector 102 are made of brass.

The adapter 100 in this way may be implemented to connect or join a PEX pipe to a pipe or hose having a male GHT, for example, to provide a flow of a fluid 160 between the male GHT connector and the PEX pipe in one or more directions. The female connector 102 and the male connector 104 in this way may be directly connected to facilitate such a connection between a male GHT connector and a PEX pipe. For example, the adapter 100 may facilitate connecting a male GHT connector with a PEX pipe without implementing multiple or numerous intermediate components and/or without converting or adapting the male GHT connector and/or PEX pipe to one or more additional piping specifications or standards, such as NPT.

FIG. 2 illustrates a side cross-sectional view of an adapter 200, according to at least one embodiment of the present disclosure. The adapter 200 may be substantially similar to and/or may include any of the features of the adapter 200 as described herein in connection with FIG. 1-2 through 1-6. For example, the adapter 200 may include a female connector 202 having threads 206 formed within an inner bore 214 and configured to connect to a male GHT connector as described herein. The adapter 200 may include a male connector 204. The male connector 204 includes a barb 234 having one or more ribs 242 and configured to connect to a PEX tubing as described herein.

In the adapter 200, the male connector 204 and the female connector 202 are connected with an integral connection. For example, the female connector 202 and the male connector 204 may be integrally formed, for example, as one piece. In this way, an interface 220 between the female connector 202 and the male connector 204 may be a solid or integral interface. For example, a female base of the female connector 202 as described herein and a male base of the male connector 204 as described herein may be integrally connected and/or may be a same base, section, or piece of material. In this way, the adapter 200 may be formed with the male connector 204 and the female connector 202 being a single and/or solid integral part. The adapter 200 may include a seal 254 positionable within the female connector for sealing a male GHT connector against the male connector 204 as described herein.

FIGS. 3-1 through 3-5 illustrate various configurations of a female connector (collectively 302) as described herein implemented with various configurations of tighteners (collectively 326) as described herein. The various female connectors 302 may be implemented with the various configurations of tighteners 326 to facilitate gripping, grasping, or otherwise securing the female connectors 302 with a hand, tool, or other implement, for example, for tightening the female connectors 302 against a male GHT connector as described herein.

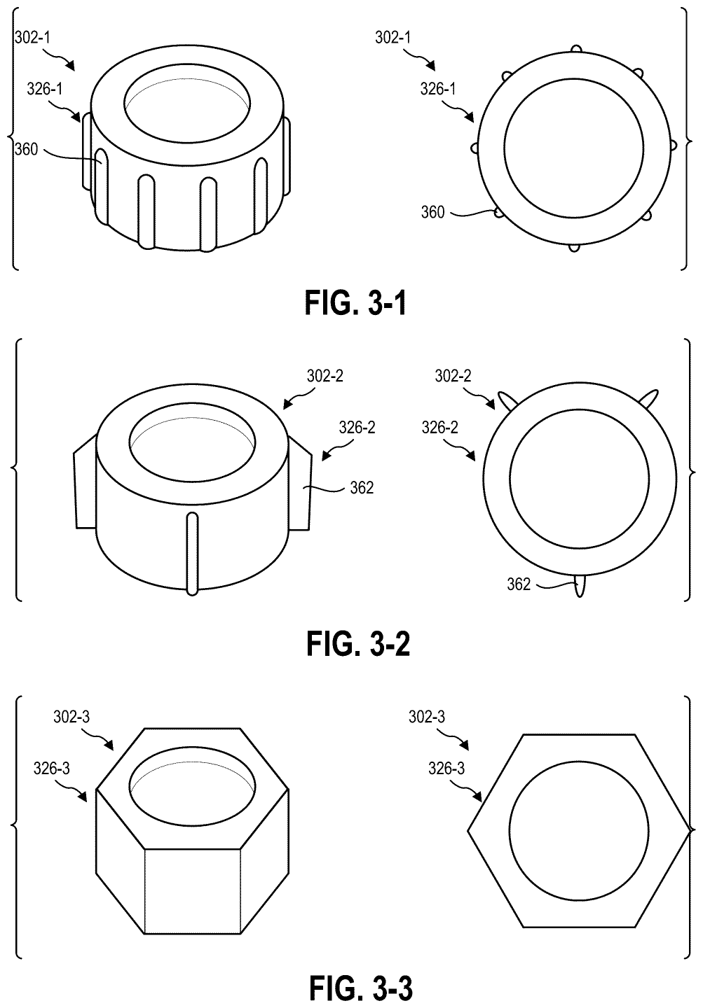

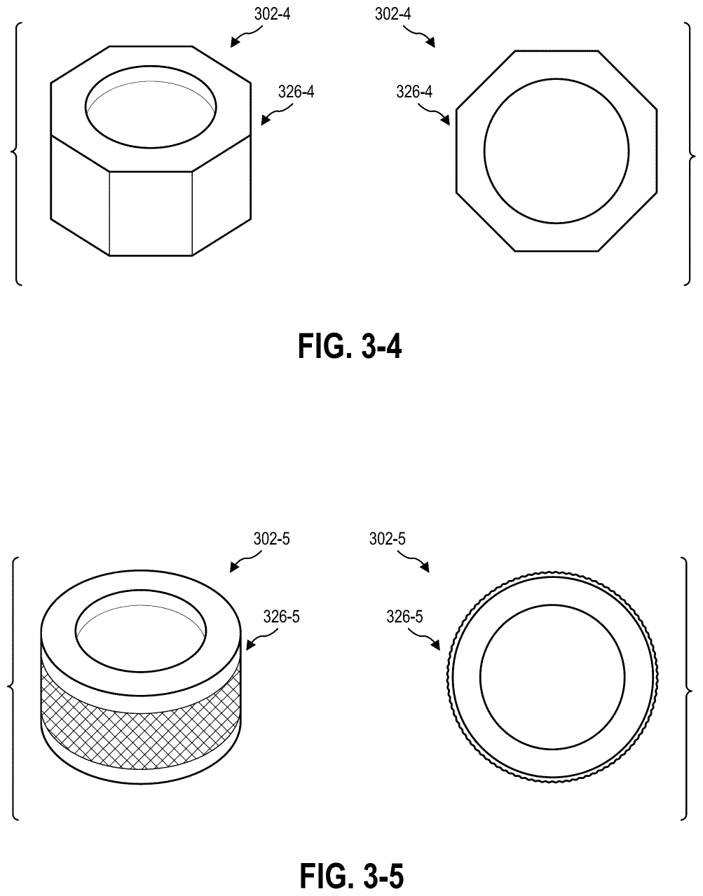

Specifically, FIG. 3-1 illustrates a perspective view and a top view of a female connector 302-1 implemented with a tightener 326-1, according to at least one embodiment of the present disclosure. The tightener 326-1 may include one or more ribs 360 positioned around an outer surface of the female connector 302-1. The ribs 360 may include one or more ribs, protrusions, or other surface features which may extend from the female connector 302-1.

FIG. 3-2 illustrates a perspective view and a top view of a female connector 302-2 implemented with a tightener 326-2, according to at least one embodiment of the present disclosure. The tightener 326-2 may include one or more wings 362 positioned around an outer surface of the female connector 302-2. The wings 362 may include one or more wings, ears, flaps, surfaces, or arms which may extend from the female connector 302-2.

FIG. 3-3 illustrates a perspective view and a top view of a female connector 302-3 implemented with a tightener 326-3, according to at least one embodiment of the present disclosure. The tightener 326-3 may be implemented as an outer surface of the female connector 302-3 formed as a hexagonal nut. The hexagonal nut may be formed as one continuous hexagonal nut section, or may be formed of two or more discontinuous hexagonal nut sections, such as that shown and described in connection with FIGS. 1-1 through 1-6.

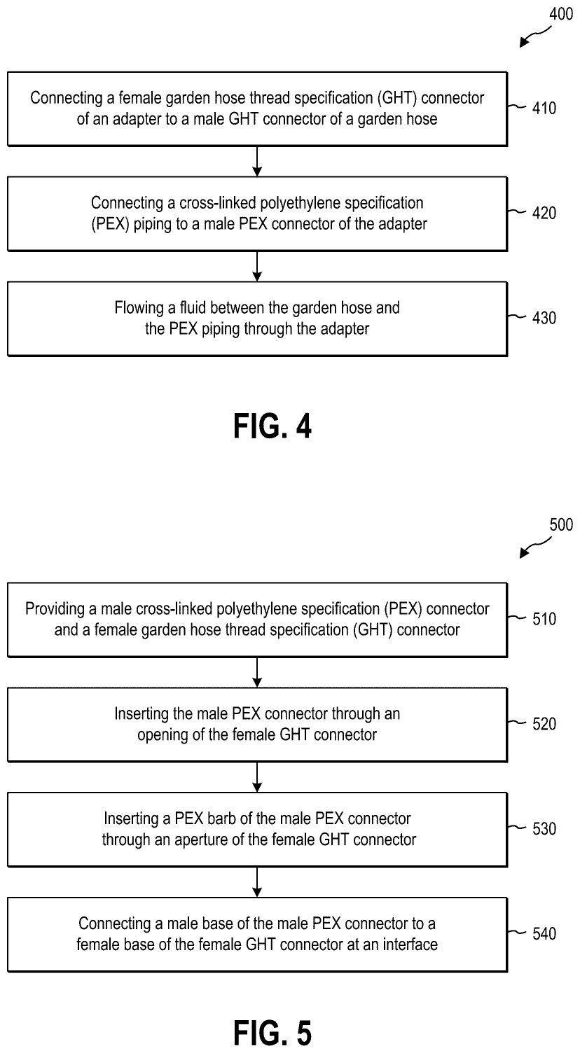

FIG. 3-4 illustrates a perspective view and a top view of a female connector 302-4 implemented with a tightener 326-4, according to at least one embodiment of the present disclosure. The tightener 326-4 may be implemented as an outer surface of the female connector 302-4 formed as an octagonal nut. The octagonal nut may be formed as one continuous octagonal nut section, or may be formed of two or more discontinuous octagonal nut sections.

FIG. 3-5 illustrates a perspective view and a top view of a female connector 302-5 implemented with a tightener 326-5, according to at least one embodiment of the present disclosure. The tightener 326-5 may be implemented as a surface texture on the outer surface of the female connector 302-5. For example, the surface texture may include knurling, grooves, or another surface pattern or surface roughness. For instance, the surface texture may be stamped, cut, grinded, sand blasted, turned, or etched into the outer surface of the female connector 302-5. The surface texture may be positioned on some or all of the exterior surface of the female connector 302-5.

Any of the tighteners 326 (or other tightener described herein) may be combined and/or implemented in combination for providing a tightener of a female connector to facilitate gripping the female connector with a hand or tool. For instance, a tightener may be implemented as two or more of the tighteners described. For example, a tightener may be implemented based on a combination of the tightener techniques described herein in two or more continuous, discontinuous, partially overlapping, fulling overlapping, or other sections of tighteners to facilitate tightening the female connector as described herein.

FIG. 4 illustrates a method 400 or a series of acts for using a piping adapter as described herein, according to at least one embodiment of the present disclosure. While FIG. 4 illustrates acts according to one embodiment, alternative embodiments may add to, omit, reorder, or modify any of the acts of FIG. 4.

In some embodiments, the method 400 includes an act 410 of connecting a female garden hose thread specification (GHT) connector of the adapter to a male GHT connector of a garden hose.

In some embodiments, the method 400 includes an act 420 of connecting a cross-linked polyethylene specification (PEX) piping to a male PEX connector of the adapter.

In some embodiments, the method 400 includes an act 430 of flowing a fluid between the garden hose and the PEX piping through the adapter.

In some embodiments, connecting the female GHT connector includes rotating the female GHT connector with respect to the male PEX connector.

In some embodiments, the method 400 further includes sealing the male GHT connector to the male PEX connector.

In some embodiments, sealing includes positioning a seal between a distal end of the male GHT connector and a male base of the male PEX connector.

In some embodiments, sealing includes sealing a distal end of the male GHT connector against a male base of the male PEX connector.

In some embodiments, flowing the fluid include flowing the fluid without the fluid leaking.

In some embodiments, the method 400 further includes, prior to connecting the female GHT connector, connecting the PEX connector to the female GHT connector.

In some embodiments, connecting the male PEX connector to the female GHT connector includes positioning the male PEX connector in the female GHT connector.

In some embodiments, the method 400 further includes connecting the male PEX connector directly to the female GHT connector.

In some embodiments, the method 400 further includes connecting the male PEX connector to the female GHT connector without using any additional fittings for connecting the PEX connector to the female GHT connector.

In some embodiments, the method further includes, prior to connecting the female GHT connector, positioning a seal in the female GHT connector.

FIG. 5 illustrates a method 500 or a series of acts for assembling a piping adapter as described herein, according to at least one embodiment of the present disclosure. While FIG. 5 illustrates acts according to one embodiment, alternative embodiments may add to, omit, reorder, or modify any of the acts of FIG. 5.

In some embodiments, the method 500 includes an act 510 of providing a male cross-linked polyethylene specification (PEX) connector and a female garden hose thread specification (GHT) connector.

In some embodiments, the method 500 includes an act 520 of inserting the male PEX connector through an opening of the female GHT connector.

In some embodiments, the method 500 includes an act 530 of inserting a PEX barb of the male PEX connector through an aperture of the female GHT connector In some embodiments, the method 500 includes an act 540 of connecting a male base of the male PEX connector to a female base of the female GHT connector at an interface.

In some embodiments, the method 500 further includes connecting the male base to the female base with a rotatable connection.

In some embodiments, connecting the male base to the female base includes inserting a gauge section of the male base at least partially into the aperture.

In some embodiments, connecting the male base to the female base includes positioning a flange section of the male base above the aperture to prevent the male base from passing through the aperture.

In some embodiments, the method further includes positioning a seal within the female GHT connector based on inserting the seal through the opening.

In some embodiments, the method 500 further includes connecting the male base to the female base based on positioning a seal within the female GHT connector.

In some embodiments, connecting the male base to the female base is further based on retaining a position of the seal in the female GHT connector with a retainer of the seal engaging a relief of the female GHT connector.

In some embodiments, the male PEX connector is configured to connect to a PEX piping and the female GHT connector is configured to connect to a male GHT connector.

### INDUSTRIAL APPLICABILITY

The following are non-limiting examples of embodiments of the present disclosure:
A1. An adapter, comprising:
   a female garden hose thread (GHT) connector having interior threads and configured to connect to a male GHT connector;
   a male cross-linked polyethylene specification (PEX) connector configured to connect to a PEX tubing;
   an interface between the male PEX connector and the female GHT connector connecting the male PEX connector to the female GHT connector; and
   a tightener positioned around an outer surface of the female GHT connector.
A2. The adapter of A1, wherein the male PEX connector is connected to the female GHT connector at the interface with a rotatable connection.
A3. The adapter of A1 or A2, further comprising a seal positioned within the female connector for sealing the male GHT connector against the male PEX connector.
A4. The adapter of A3, wherein the seal is positioned between a distal end of the male GHT connector and a base of the male PEX connector to seal the distal end of the male GHT connector against the base of the male PEX connector.
A5. The adapter of A3 or A4, wherein the seal is one or more of a gasket, washer, or O-ring.
A6. The adapter of any of A3-A5, wherein the female GHT connector includes a relief for maintaining a position of the seal with one or more retainers of the seal.
A7. The adapter of any of A1-A6, wherein the male PEX connector includes at least one rib positioned around an outer surface of the male PEX connector.
A8. The adapter of A7, wherein the at least one rib is a first rib of a plurality of ribs positioned around the outer surface of the male PEX connector, and wherein a second rib of the plurality of ribs is tapered and is positioned at a distal end of the male PEX connector.
A9. The adapter of any of A1-A8, wherein the male PEX connector comprises a PEX insertion fitting of a nominal size of ⅜-inch, ½-inch, ⅝-inch, ¾-inch, or 1-inch.
A10. The adapter of any of A1-A9, wherein the male PEX connector comprises a PEX crimp fitting.
A11. The adapter of any of A1-A10, wherein the female GHT connector is a ¾-inch national hose thread (NH) or GHT fitting.
A12. The adapter of any of A1-A11, wherein the interior threads of the female GHT connector are parallel threads.
A13. The adapter of any of A1-A12, wherein the interior threads of the female GHT connector have a pitch of 11.5 threads per inch.
A14. The adapter of any of A1-A13, wherein the male PEX connector and female GHT connector each have and internal bore.
A15. The adapter of any of A1-A14, wherein the male PEX connector and the female GHT connector are coaxial.
A16. The adapter of any of A1-A15, wherein the male PEX connector and the female GHT are directly connected.
A17. The adapter of any of A1-A16, wherein the tightener includes one or more of a hex nut, an octagonal nut, a rib, a wing, or knurling.
A18. The adapter of any of A1-A17, wherein the female GHT connector and the male PEX connector are made of one or more of a metal or a polymer.
B1 . an adapter, comprising:
   a female garden hose thread (GHT) connector having interior threads and configured to connect to a male GHT connector;
   a male cross-linked polyethylene specification (PEX) connector configured to connect to a PEX tubing;
   a rotatable connection between the male PEX connector and the female GHT connector; and
   a seal positioned within the female GHT connector for sealing the male GHT connector against the male PEX connector.
C1. An adapter, comprising:
   a female garden hose thread (GHT) connector with a nominal diameter of ¾ inches and having interior threads for connecting the female GHT connector to a ¾-inch male GHT connector;
   a male cross-linked polyethylene specification (PEX) connector comprising a base, and comprising a male PEX insertion fitting for connecting the male PEX connector to a PEX tubing with a crimped connection;
   an interface between the male PEX connector and the female GHT connector directly connecting the male PEX connector to the female GHT connector with a rotatable connection;
   a tightener positioned around an outer surface of the female GHT connector for tightening the female GHT connector to the male GHT connector; and
   a seal positioned within the female GHT connector adjacent the interface for sealing a distal end of the male GHT connector against the base of the male PEX connector based on tightening the female GHT to the male GHT connector with the tightener.
D1. A male pipe connector, comprising:
   a cross-linked polyethylene specification (PEX) barb;
   at least one PEX rib positioned on the PEX barb; and
   a male base connected to the PEX barb, wherein the male base is configured to connect to a female garden hose thread specification (GHT) connector having interior threads for connecting to a male GHT connector.
D2. The male pipe connector of D1, wherein the male base includes a means for maintaining the male pipe connector in the female GHT connector.
D3. The male pipe connector of D2, wherein the means for maintaining includes a flange section of the male base.
D4. The male pipe connector of D3, wherein the flange section has a dimension that is greater than a dimension of an aperture of the female GHT connector such that the flange section does not pass through the aperture.
D5. The male pipe connector of D3 of D4, wherein the flange section has a wider diameter than a diameter of the aperture.
D6. The male pipe connector of any of D2-D5, wherein the male base includes a means for positioning the male pipe connector in the female GHT connector.
D7 The male pipe connector of D6, wherein the means for positioning include a gauge section of the male base.
D8. The male pipe connector of D7, wherein the gauge section at least partially inserts into an aperture of the female GHT connector.
D9 The male pipe connector of D7 or D8, wherein the gauge section has a shape that is complimentary to a shape of an aperture of the female GHT connector to maintain a position of the gauge section.
D10. The male pipe connector of claim 7, wherein the gauge section has a round shape having a same diameter of a round shape of an aperture of the female GHT connector.
D11. The male pipe connector of any of D1-D10, wherein the male base has a flat upper surface for sealing against a distal end of the male GHT connector.
D12. The male pipe connector of any of D1-D11, wherein the PEX barb is not a barbed fitting connector.
D13. The male pipe connector of any of D1-D12, wherein the PEX barb is not a polybutylene (PB) fitting.
E1. A method of using a piping adapter, comprising:
   connecting a female garden hose thread specification (GHT) connector of the adapter to a male GHT connector of a garden hose;
   connecting a cross-linked polyethylene specification (PEX) piping to a male PEX connector of the adapter; and
   flowing a fluid between the garden hose and the PEX piping through the adapter.
E2. The method of E1, wherein connecting the female GHT connector includes rotating the female GHT connector with respect to the male PEX connector.
E3. The method of E1 or E2, further comprising sealing the male GHT connector to the male PEX connector.
E4. The method of E3, wherein sealing includes positioning a seal between a distal end of the male GHT connector and a male base of the male PEX connector.
E5. The method of E3 or E4, wherein sealing includes sealing a distal end of the male GHT connector against a male base of the male PEX connector.
E6. The method of any of E1-E5, wherein flowing the fluid include flowing the fluid without the fluid leaking.
E7. The method of any of E1-E6, further comprising, prior to connecting the female GHT connector, connecting the PEX connector to the female GHT connector.
E8. The method of E7, wherein connecting the male PEX connector to the female GHT connector includes positioning the male PEX connector in the female GHT connector.
E9 The method of E7 or E8, further comprising connecting the male PEX connector directly to the female GHT connector.
E10. The method of any of E7-E9, further comprising connecting the male PEX connector to the female GHT connector without using any additional fittings for connecting the male PEX connector to the female GHT connector.
E11. The method of any of E1-E10, further comprising, prior to connecting the female GHT connector, positioning a seal in the female GHT connector.
F1. A method of assembling a piping adapter, comprising:
   providing a male cross-linked polyethylene specification (PEX) connector and a female garden hose thread specification (GHT) connector;
   inserting the male PEX connector through an opening of the female GHT connector;
   inserting a PEX barb of the male PEX connector through an aperture of the female GHT connector; and
   connecting a male base of the male PEX connector to a female base of the female GHT connector at an interface.
F2. The method of F1, further comprising connecting the male base to the female base with a rotatable connection.
F3. The method of F1 or F2, wherein connecting the male base to the female base includes inserting a gauge section of the male base at least partially into the aperture.
F4. The method of any of F1-F3, wherein connecting the male base to the female base includes positioning a flange section of the male base above the aperture to prevent the male base from passing through the aperture.
F5. The method of any of F1-F4, further comprising positioning a seal within the female GHT connector based on inserting the seal through the opening.
F6. The method of any of F1-F5, further comprising connecting the male base to the female base based on positioning a seal within the female GHT connector.
F7. The method of any of F6, wherein connecting the male base to the female base is further based on retaining a position of the seal in the female GHT connector with a retainer of the seal engaging a relief of the female GHT connector.
F8. The method of cany of F1-F7, wherein the male PEX connector is configured to connect to a PEX piping and the female GHT connector is configured to connect to a male GHT connector.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A pipe connector, comprising:
a female coupling being a ¾-inch nominal garden hose thread (GHT) coupling having interior threads that are parallel with a pitch of 11.5 threads per inch;
an insert nipple configured to connect to a cross-linked polyethylene (PEX) tubing;
a plurality of ribs positioned on the insert nipple, wherein each rib has a top face and a bottom face that are parallel and that extend from an outer surface of the insert nipple, and a side face therebetween;
a male base connected to the insert nipple; and
an interface between the male base and the female coupling connecting the insert nipple to the female coupling.

2. pipe connector of claim 1, wherein the plurality of ribs are spaced along the insert nipple with a rib spacing defined between the bottom face of first rib and the top face of a next rib.

3. The pipe connector of claim 1, further comprising a tube stop positioned on the insert nipple and raised from the outer surface of the insert nipple, wherein the tube stop is positioned at a shoulder between the male base and the insert nipple and the tube stop is connected to the insert nipple and to the male base.

4. The pipe connector of claim 3, wherein the tube stop has an outer diameter that is the same as a rib diameter of the plurality of ribs.

5. The pipe connector of claim 3, wherein the plurality of ribs are not sawtooth barbs.

6. (canceled)

7. The pipe connector of claim 1, wherein the plurality of ribs each have a rib height of at least 0.013 inches.

8. The pipe connector of claim 1, wherein the plurality of ribs each have a rib width of between about 0.03 inches and about 0.05 inches.

9. An adapter, comprising:
a female garden hose thread (GHT) connector being a female connector conforming to a GHT specification, wherein the GHT specification is the American National Standards Institute (ANSI) standard specification for hose coupling screw threads, the female GHT connector having interior threads and configured to connect to a male GHT connector being a male connector conforming to the GHT specification;
a male cross-linked polyethylene (PEX) connector being a male connector conforming to a PEX specification, wherein the PEX specification is the American Society for Testing and Materials (ASTM) standard specification for insert fittings for PEX tubing;
an interface between the male PEX connector and the female GHT connector connecting the male PEX connector to the female GHT connector; and
a tightener positioned around an outer surface of the female GHT connector.

10. The adapter of claim 9, wherein the PEX specification is the specification as outlined in ASTM F1807.

11. The adapter of claim 9, wherein the GHT specification is the specification as outlined in ANSI-ASME B1.20.7.

12. The adapter of claim 11, further comprising a seal positioned within the female GHT connector for sealing the male GHT connector against the male PEX connector, and wherein the female GHT connector includes a relief for maintaining a position of the seal with one or more retainers of the seal.

13. The adapter of claim 9, wherein the male PEX connector includes at least one rib positioned around an outer surface of the male PEX connector, wherein the at least one rib is a rib in accordance with the PEX specification.

14. The adapter of claim 9, wherein the male PEX connector comprises a PEX insert nipple of a nominal size of ⅜-inch, ½-inch, ⅝-inch, ¾-inch, or 1-inch.

15. The adapter of claim 9, wherein the female GHT connector is a GHT coupler of a nominal size of ¾-inch, and the interior threads are parallel threads having a pitch of 11.5 threads per inch.

16. The adapter of claim 9, wherein the tightener includes one or more of a hex nut, an octagonal nut, a rib, a wing, or knurling.

17-20. (canceled)

21. The pipe connector of claim 1, wherein the female coupling, the insert nipple, and the male base are each made out of a metal.

22. The pipe connector of claim 1, wherein the side face of each of the plurality of ribs is parallel to the insert nipple.

23. the pipe connector of claim 1, wherein the top face and the bottom face of each of the plurality of ribs is perpendicular to the insert nipple.

24. The pipe connector of claim 1, wherein, for each of the plurality of ribs, the side face is a face that faces the male base, and wherein side face and the top face are joined with a radius.

25. A pipe adapter, comprising:
a female coupling being a ¾-inch nominal garden house thread (GHT) coupling having interior threads that are parallel with a pitch of 11.5 threads per inch;
an insert nipple configured to connect to a cross-linked polyethylene (PEX) tubing;
a male base connected to the insert nipple;
an interface between the male base and the female coupling connecting the insert nipple to the female coupling;
a plurality of ribs positioned on the insert nipple, each rib having a top face and a bottom face that are parallel and that extend from an outer surface of the insert nipple, and a side face therebetween, wherein the plurality of ribs are spaced along the insert nipple with a rib spacing defined between a bottom face of a first rib and a top face of a next rib;
a tube stop positioned on the insert nipple and raised therefrom, wherein the tube stop is positioned at a shoulder between the male base and the insert nipple, and the tube stop is connected to the insert nipple and to the male base; and
a chamfer at a distal end of the insert nipple having an angle between 10° and 30°.
